(19) United States
(12) Patent Application Publication
(10) Pub. No.: US 2026/0120595 A1
(43) Pub. Date: Apr. 30, 2026

(54) Tangle Resistant Flag System and Related Methods

(71) Applicant: Free Wave Flags, LLC, Batavia, OH (US)

(72) Inventor: Eric R. Bartlam, Batavia, OH (US)

(21) Appl. No.: 19/371,222

(22) Filed: Oct. 28, 2025

Related U.S. Application Data
(60) Provisional application No. 63/713,610, filed on Oct. 30, 2024.
(60) Provisional application No. 63/851,940, filed on Jul. 27, 2025.

(51) Int. Cl. G09F 17/00

(52) U.S. Cl. CPC G09F 17/0091; G09F 2017/005

(57) ABSTRACT

A tangle resistant flag includes a flag edge portion and an elongated member. The elongated member is coupled to the flag edge portion. The elongated member is configured to prevent the flag from becoming tangled around a flagpole.

### CROSS REFERENCE TO RELATED APPLICATION

This application is related to Application Ser. No. 63/713,610, filed on Oct. 30, 2024 (pending) and Application Ser. No. 63/851,940, filed on Jul. 27, 2025 (pending), the disclosures of which are hereby fully incorporated by reference herein.

### TECHNICAL FIELD

Embodiments generally relate to flags, flagpoles, and related methods.

### BACKGROUND

It is desirable to display flags outside of homes, businesses, and organizations. Often times flags are suspended from flagpoles that are mounted to buildings, or other structures, at an angle such that the flagpole is not in a vertical orientation. When a flagpole is not oriented vertically, a flag will have a tendency to become wrapped around the flagpole. Often, when a flag becomes wrapped around the flagpole, the flag will not unwrap from the flagpole without outside intervention. Additionally, flags that are suspended from flagpoles that are mounted to buildings, or other structures, often get caught on portions of the structure, such as gutters, for example. Other times, flags that are suspended from flagpoles that are mounted to buildings, or other structures, will rub against or get caught on the rough surfaces of the structure, such as bricks, stone, concrete, mortar, stucco, or rough-hewn siding, for example. Accordingly, there is a need for improvements related to flags and flagpoles.

### SUMMARY

Generally, a tangle resistant flag is provided herein. The flag includes a flag edge portion and an elongated member. The elongated member is coupled to the flag edge portion and is configured to prevent the flag from becoming tangled around a flagpole.

In some embodiments, the flag edge portion may include a flag pocket and the elongated member may be at least partially contained in the flag pocket. The elongated member may be flexible. The elongated member may be at least one of fiberglass or carbon fiber. The elongated member may extend at least half a length of the flag. The elongated member may be a rod between 1/16″ and ⅜″ diameter. The elongated member may extend the length of the flag. The elongated member may be removably coupled to the flag edge portion. The flag may include a header and at least a portion of the elongated member may extend into the header. A flag system may include the flag and a flag bracket configured to couple the flag to a flagpole. The flag bracket may include a bracket tab associated with the elongated member. The flag bracket may include a first bracket tab and a second bracket tab and a portion of the elongated member may be configured to be located between the first bracket tab and the second bracket tab. The flag bracket may include a flag bracket stop member configured to limit the rotation of the flag bracket around a flagpole. The flag system may include a stop bracket configured to limit the rotation of the flag bracket around a flagpole. The elongated member may include an anchor member configured to be coupled to the flag bracket. The anchor member may include a stop portion configured to limit the rotation of the elongated member relative to the flag bracket. The flag system may include a flagpole. The flag system may include a flagpole bracket configured to be coupled to a mounting surface and to receive a portion of the flagpole.

In alternative embodiments, the flag edge portion may be a first flag edge portion. The elongated member may be a first elongated member. The flag may include a second flag edge portion and a second elongated member. The second elongated member may be coupled to the second flag edge portion. The second elongated member may be configured to prevent the flag from becoming tangled around the flagpole. The first flag edge portion may include a first flag pocket and the first elongated member may be at least partially contained in the first flag pocket. The second flag edge portion may include a second flag pocket and the second elongated member may be at least partially contained in the second flag pocket. At least one of the first elongated member or the second elongated member may extend at least half a length of the flag. The flag may include a header. At least a portion of the first elongated member may extend into the header. At least one of the first elongated member or the second elongated member may be flexible. At least one of the first elongated member or the second elongated member may be at least one of fiberglass or carbon fiber. At least one of the first elongated member or the second elongated member may be a rod between 1/16″ and ⅜″ diameter. At least one of the first elongated member or the second elongated member may be removably coupled to the first flag edge portion or the second flag edge portion. At least a portion of the second elongated member may extend into the header.

A tangle resistant flag system is provided herein. The flag system includes a flag, a first flag mounting bracket, and a second flag mounting bracket. The flag includes a first flag edge portion, a second flag edge portion, a first elongated member, and a second elongated member. The first elongated member is coupled to the first flag edge portion and configured to prevent the flag from becoming tangled around a flagpole. The second elongated member is coupled to the second flag edge portion and configured to prevent the flag from becoming tangled around the flagpole. The first flag mounting bracket is configured to couple the flag to a flagpole. The second flag mounting bracket configured to couple the flag to the flagpole.

In alternative embodiments, the first flag mounting bracket may include a first bracket tab associated with the first elongated member. The second flag mounting bracket may include a second bracket tab associated with the second elongated member. The first flag mounting bracket may include a first bracket tab and a second bracket tab. A portion of the first elongated member may be configured to be located between the first bracket tab and the second bracket tab. The second flag mounting bracket may include a third bracket tab and a fourth bracket tab. A portion of the second elongated member may be configured to be located between the third bracket tab and the fourth bracket tab. The first flag mounting bracket may include a first flag mounting bracket stop member configured to limit the rotation of the first flag mounting bracket around the flagpole. The second flag mounting bracket may include a second flag mounting bracket stop member configured to limit the rotation of the second flag mounting bracket around the flagpole. The flag may include a header. At least a portion of the first elongated member may extend into the header. At least a portion of the second elongated member may extend into the header. At least one of the first elongated member or the second elongated member may extend at least half a length of the flag. At least one of the first elongated member or the second elongated member may be flexible. At least one of the first elongated member or the second elongated member may be at least one of fiberglass or carbon fiber. At least one of the first elongated member or the second elongated member may be a rod between 1/16″ and ⅜″ diameter. The first elongated member may extend the length of the flag. At least one of the first elongated member or the second elongated member may be removably coupled to the first flag edge portion or the second flag edge portion.

The flag system may include a first stop bracket configured to limit the rotation of the first flag bracket around a flagpole. The flag system may include a second stop bracket configured to limit the rotation of the second flag bracket around a flagpole. The first elongated member may include a first anchor member configured to be coupled to the first flag bracket. The first anchor member may include a stop portion configured to limit the rotation of the first elongated member relative to the first flag bracket. The second elongated member may include a second anchor member configured to be coupled to the second flag bracket. The second anchor member may include a stop portion configured to limit the rotation of the second elongated member relative to the second flag bracket. The flag system may include the flagpole. The flag system may include a flagpole bracket configured to be coupled to a mounting surface and to receive a portion of the flagpole.

A method of manufacturing a tangle resistant flag is provided herein. The method includes creating a flag pocket configured to receive at least a portion of an elongated member along at least a portion of an edge portion of the flag. The method also includes inserting at least a portion of an elongated member configured to prevent the flag from becoming tangled around a flagpole into the flag pocket.

In some embodiments, the method may include installing a header on the flag and inserting a portion of the elongated member into the header. The edge portion of the flag may be a first edge portion. The flag pocket may be a first flag pocket. The elongated member may be a first elongated member. The method may include creating a second flag pocket configured to receive at least a portion of an elongated member along at least a portion of a second edge portion of the flag. The method may include inserting at least a portion of a second elongated member configured to prevent the flag from becoming tangled around the flagpole into the second flag pocket. The method may include inserting a portion of the second elongated member into the header.

Additional features and advantages of the inventive aspects will become more apparent upon review of the following detailed description taken together with accompanying drawings of the illustrative and exemplary embodiments.

### BRIEF DESCRIPTION OF THE DRAWINGS

FIG. 1 is a perspective view of an illustrative tangle resistant flag system including a flag, flagpole, and flag mounting bracket assemblies.

FIG. 2 is an alternative perspective view of the flag system of FIG. 1.

FIG. 3 is a front view of the flag of the flag system of FIG. 1.

FIG. 4 is a fragmentary front view of the flag of FIG. 3.

FIG. 5 is a fragmentary view of a portion of an upper edge portion of the flag of FIG. 3.

FIG. 6 is a sectional view of a portion of the upper edge portion of the flag of FIG. 3.

FIG. 7 is a fragmentary view of a portion of the lower edge portion of the flag of FIG. 3.

FIG. 8 is a sectional view of a portion of the lower edge portion of the flag of FIG. 3.

FIG. 9 is an elevation view of a portion of the flag system of FIG. 1, including an upper corner portion of the flag, a portion of the flagpole, and a flag mounting bracket assembly.

FIG. 10 is an elevation view of a portion of the flag system of FIG. 1, including a lower corner portion of the flag, a portion of the flagpole, and a flag mounting bracket assembly.

FIG. 11 is a perspective view of a flag mounting bracket.

FIG. 12 is a perspective view of a stop bracket.

FIG. 13 is a detail view of a portion of the flag system of FIG. 1 illustrating the mounting of the flag to a flag mounting bracket and the flagpole.

FIG. 14 is a simplified end view of the flag system of FIG. 1 with the flag hanging downward.

FIG. 15 is a simplified end view of the flag system 100 of FIG. 1 with the flag rotated counterclockwise approximately 70°-80°.

FIG. 16 is a simplified end view of the flag system of FIG. 1 with the flag rotated counterclockwise approximately 70°-80°.

FIG. 17 is a partial section view of the flag system of FIG. 1 with the flag hanging downward.

FIG. 18 is a partial section view of the flag system of FIG. 1 with the flag rotated clockwise approximately 70°-80°.

FIG. 19 is a partial section view of the flag system of FIG. 1 with the flag rotated counterclockwise approximately 70°-80°.

FIG. 20 is a perspective view of an alternative illustrative tangle resistant flag system including a flag, flagpole, and flag mounting bracket assemblies.

FIG. 21 is a front view of the flag of the tangle resistant flag system of FIG. 20.

FIG. 22 is a fragmentary front view of the flag of FIG. 21.

FIG. 23 is a detail view of a portion of the flag system of FIG. 20 illustrating the mounting of the flag to a flag mounting bracket and the flagpole.

FIG. 24 is an elevation view of an upper portion of the flag system of FIG. 21 including an upper corner portion of the flag, a portion of the flagpole, and a flag mounting bracket assembly.

FIG. 25 is an elevation view of an upper portion of the flag system of FIG. 21 including an upper corner portion of the flag, a portion of the flagpole, and a flag mounting bracket assembly, with the flag hanging similarly to the flag in FIG. 1.

### DETAILED DESCRIPTION

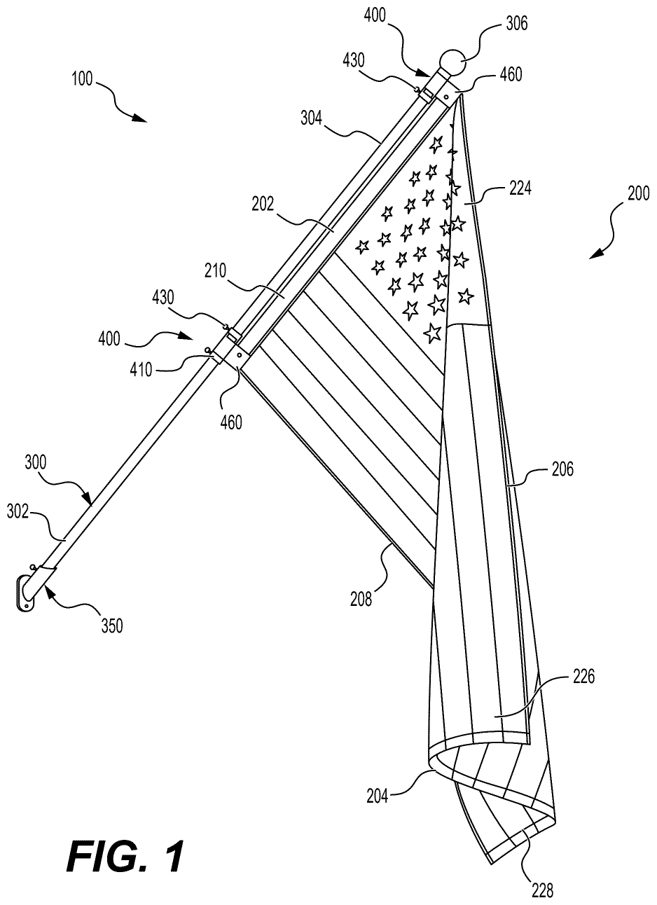

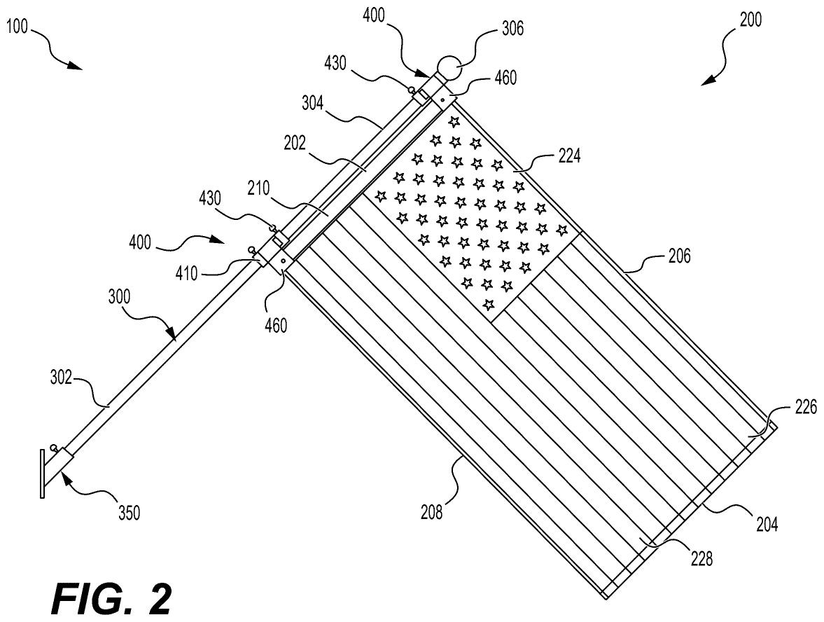

FIGS. 1 and 2 are perspective views of a tangle resistant flag system 100. In this illustrative embodiment, the flag system 100 includes a flag 200, a flagpole 300, a flagpole mounting bracket 350, and flag mounting bracket assemblies 400. The flag system 100 is configured to prevent the flag 200 from wrapping around or becoming entangled around the flagpole 300. FIG. 1 shows the flag 200 hanging naturally from the pole 300, such as when there is no breeze to cause the flag to “fly”. FIG. 2 shows the flag 200 extending outwardly from the pole 300 to illustrate the various components of the flag system 100. The following disclosure will make clear that the flag 200 is not to extend perpendicular from the flagpole 300 when there is no breeze to cause the flag to “fly” or for the flag 200 to otherwise appear unnaturally rigid when displayed. The flagpole 300 includes a mounting end portion 302, a flag supporting portion 304, and a decorative end portion 306. The mounting end portion 302 fits into the flagpole mounting bracket 350. In some embodiments, the flag system 100 may include a pole mounted light, such as a solar powered light, to illuminate the flag 200.

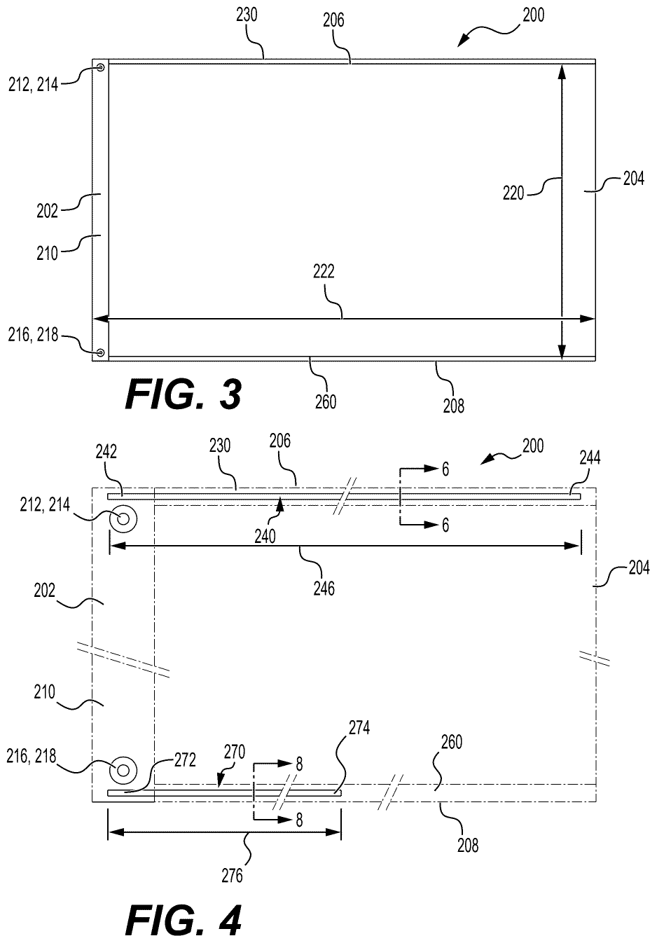

FIG. 3 is a front view of an illustrative embodiment of the flag 200. FIG. 4 is a fragmentary front view of the flag 200 with portions of the flag 200 shown in phantom for illustrative purposes. The flag 200 includes a pole side portion 202 and opposite the pole side portion 202 is the fly end portion 204. The fly end portion 204 is the side or end of the flag 200 that is farthest away from the flagpole 300, see FIG. 2, and the end of the flag 200 that “flies” freely. The flag 200 also includes an upper edge portion 206 and a lower edge portion 208.

In this illustrative embodiment, the pole side portion 202 includes a header 210 which is a band of material that reinforces the pole side portion 202 of the flag 200. The header 210 may be made of a thick cotton/poly blend fabric that has the look and feel of canvas, for example, but may be constructed of other fabrics or materials. The pole side portion 202 includes an upper mounting hole 212 and grommet 214 and a lower mounting hole 216 and grommet 218 located in the header 210 and configured for mounting the flag 200. The grommets 214, 218 are rings or eyelets that are usually made of brass or other metal, but may be constructed of other materials. The flag 200 has a width 220 and a length 222. In FIGS. 1 and 2 the flag 200 is illustrated as a Flag of the United States, but the improvements described herein may be applied to other flag designs and configurations. The illustrative flag 200 is shown with a canton or union 224 and a field or ground including seven short stripes 226 and six long stripes 228.

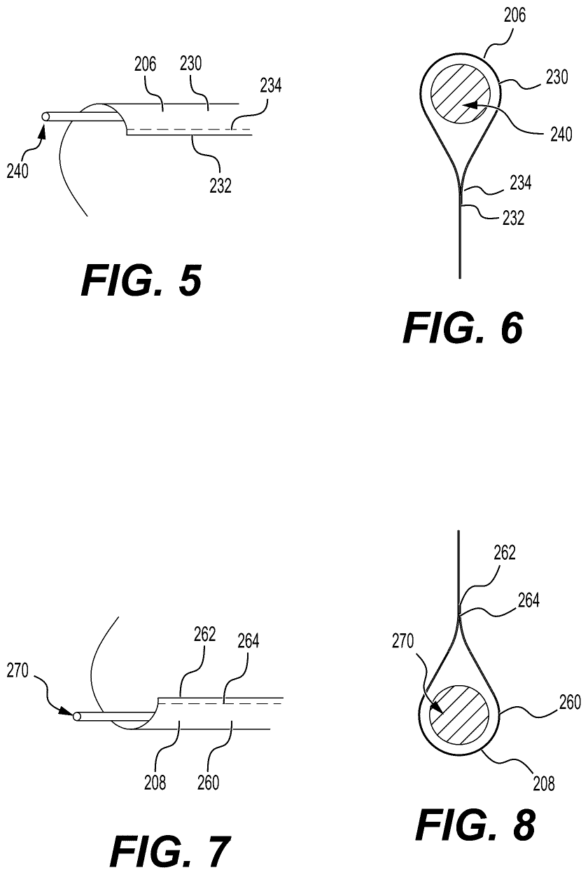

FIG. 5 is a fragmentary view of a portion of the upper edge portion 206 of the flag 200 and FIG. 6 is a sectional view of a portion of the upper edge portion 206 of the flag 200. Referring to FIGS. 3 through 6, in this illustrative embodiment, the flag 200 has a first or upper flag pocket 230 running along at least a portion of the upper edge portion 206. The first flag pocket 230 may be formed by folding over the fabric edge 232 and securing the fabric edge 232, such as hemming the edge with stitching 234 for example. A first elongated member 240 is at least partially contained in the first flag pocket 230 and an upper portion of the header 210. The first elongated member 240 has a first end portion 242 which is located proximate the pole side portion 202 and partially in the header 210, a second end portion 244, and a length 246. In this illustrative embodiment, the length 246 of the first elongated member 240 is approximately the length 222 of the flag 200. In some embodiments, the length 246 of the first elongated member 240 may be approximately half the length 222 of the flag 200. In other embodiments, the length 246 of the first elongated member 240 may be some length between one third the length 222 of the flag 200 and the length 222 of the flag 200. It should be understood that the first elongated member 240 needs to be long enough to prevent the flag 200 from wrapping around the flagpole 300. Making the length 246 of the first elongated member 240 less that the length 222 of the flag 200 may allow the fly end portion 204 to more naturally fly when displayed.

The first elongated member 240 may be inserted into the first flag pocket 230 after the first flag pocket 230 is formed. In some embodiments, the first elongated member 240 may be inserted into the first flag pocket 230 before the header 210 is attached to the flag 200. In other embodiments, the first elongated member 240 may be inserted into the first flag pocket 230 before the fly end portion 204 is stitched or hemmed or the first flag pocket 230 is completely stitched or hemmed. In this illustrative embodiment, the header 210 and the hemmed fly end portion 206 retain the first elongated member 240 in the first flag pocket 230. In some embodiments, stiches or other fastening or bonding devices, may be applied near the second end portion 244 of the first elongated member 240 to retain the first elongated member 240 in the first flag pocket 230. It should be understood that some flags may not include a header and that the improvements described herein may be applied to flags without headers. Traditionally, the upper edge portion of a flag will include a double row of stitches to help the flag retain its shape and prevent curling or warping, keeping the flag looking crisp and well-maintained. With the addition of the first elongated member 240, in some embodiments, at least a portion of the upper edge portion 206 may include only a single row of stitches.

For a flag 200 with a canton 224, when stitching the canton 224 to the field or ground, such as the seven short stripes 226 shown in FIG. 2, the hem of the seam should be oriented to allow the first elongated member 240 to be inserted into the first flag pocket 230 without catching on the seam between the canton 224 and the field. For instance, if the first elongated member 240 is to be inserted into the first flag pocket 230 before the header 210 is attached to the flag 200, the hem between the canton 224 and the field should be oriented toward the fly end portion 204. If however, the first elongated member 240 is to be inserted into the first flag pocket 230 before the fly end portion 204 is stitched or hemmed, the hem between the canton 224 and the field should be oriented toward the pole side portion 202.

FIG. 7 is a fragmentary view of a portion of the lower edge portion 208 of the flag 200 and FIG. 8 is a sectional view of a portion of the lower edge portion 208 of the flag 200. Referring to FIGS. 3, 4, 7, and 8, in this illustrative embodiment, the flag 200 has a second or lower flag pocket 260 running along at least a portion of the lower edge portion 208. The second flag pocket 260 may be formed by folding over the fabric edge 262 and securing the fabric edge 262, such as hemming the edge with stitching 264, for example. A second elongated member 270 is at least partially contained in the second flag pocket 260 and a lower portion of the header 210. The second elongated member 270 has a first end portion 272 which is located proximate the pole side portion 202 and partially in the header 210, a second end portion 274, and a length 276. In this illustrative embodiment, the second elongated member 270 is approximately half the length 222 of the flag 200. When the flag 200 is suspended at around a 45° angle, as shown in FIGS. 1 and 2, a portion of the lower edge portion 208 of the flag 200 is naturally approximately straight and perpendicular to the flagpole 300 and the second elongated member 270 should be generally unnoticeable. The second elongated member 270 needs to be long enough to prevent the flag 200 from wrapping around the flagpole 300 but not so long as to cause the second elongated member 270 to be noticeable when the flag 200 is hanging as shown in FIG. 1.

Traditionally, the lower edge portion of a flag will include a double row of stitches to help the flag retain its shape and prevent curling or warping, keeping the flag looking crisp and well-maintained. With the addition of the second elongated member 270, in some embodiments, a portion of the lower edge portion 208 may include only a single row of stitches where the second elongated member 270 is located and a double row of stitches along the balance of the lower edge portion 208. Stiches, or other fastening or bonding devices, may be applied to secure the second end portion 274 of the second elongated member 270 in the second flag pocket 260. In some embodiments, the second flag pocket 260 is formed and the second elongated member 270 is inserted into the second flag pocket 260 before the header 210 is attached to the flag 200. In other embodiments, the second elongated member 270 may be inserted into the second flag pocket 260 before the fly end portion 204 is stitched or hemmed or the second flag pocket 260 is completely stitched or hemmed.

Referring to FIGS. 2 through 4, as previously discussed, the first and second elongated members 240, 270 are configured to prevent the flag 200 from becoming tangled around the flagpole 300 while also allowing the flag 200 to hang, fly, and wave “naturally” in the wind. In some embodiments, the first and second elongated members 240, 270 may be rigid. However, if the first and second elongated members 240, 270 are too rigid, for example, the flag 200 may appear rigid or stiff which may be undesirable. On the other hand, if the first and second elongated members 240, 270 are too flexible or lack the necessary elasticity the flag 200 may become tangled around the flagpole 300. In this illustrative embodiment, the first and second elongated members 240, 270 are elastic and bias the upper and the lower edge portions 206, 208 of the flag 200 away from the flagpole 300. The first and second elongated members 240, 270 may be flexible enough to allow the flag 200 to temporarily wrap around the flagpole 300, while also possessing the rigidity to exert enough force on the upper and/or the lower edge portions 206, 208 to unwrap the flag 200 from the flagpole 300 thereby preventing the flag 200 from becoming tangled around the flagpole 300.

In some embodiments, the lengths 246, 276 of the first or second elongated members 240, 270 may be adjusted to achieve the desired appearance of the flag 200 while maintaining the tangle resistant features. The first and second elongated members 240, 270 may be constructed of fiberglass or carbon fiber, for example, but may be constructed of other materials that provide the desired combination of flexibility and elasticity. The first and second elongated members 240, 270 may be rods between 1/16″ and ⅜″ diameter, for example, but may have other diameters or cross-section profiles. The cross-section profiles of the first and second elongated members 240, 270 may vary along the lengths 246, 276 of the first and second elongated members 240, 270. For example, the first end portions 242, 272 of the first and second elongated members 240, 270 may have a larger cross-sectional area than the second ends 244, 274. Varying the cross-sectional profiles along the lengths 246, 276 of the first and second elongated members 240, 270 allows the flexibility and/or elasticity of the first and second elongated members 240, 270 to be adjusted for the best appearance when the flag 200 is hanging, flying, and waving in the wind. In some embodiments, the first and second elongated members 240, 270 may be removable from the first and second flag pockets 230, 260 for shipping, storage, replacement, and/or reuse, for example. In some embodiments, the flag 200 may have a single flag pocket and a single elongated member.

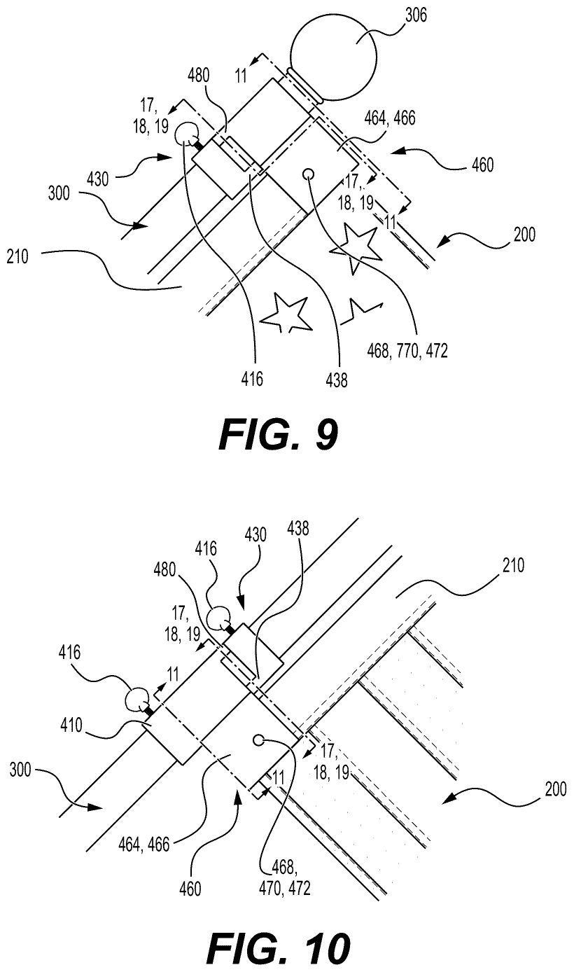

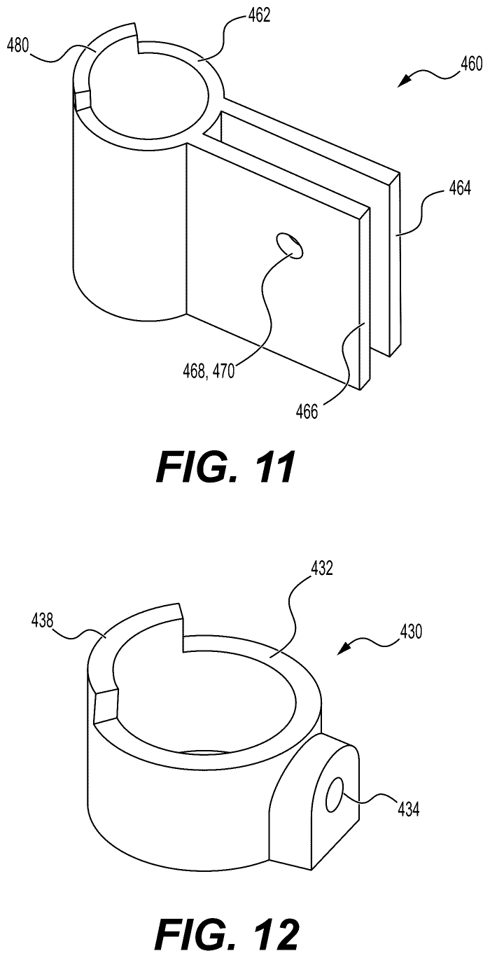

FIG. 9 is an elevation view of a portion of the flag system 100 including an upper corner portion of the flag 200, a portion of the flagpole 300, and a flag mounting bracket assembly 400. FIG. 10 is an elevation view of a portion of the flag system 100 including a lower corner portion of the flag 200, a portion of the flagpole 300, and a flag mounting bracket assembly 400. In this illustrative embodiment, the flag system 100 includes two flag mounting bracket assemblies 400 configured to couple the flag 200 to the flagpole 300. The flag mounting bracket assemblies 400 include stop brackets 430 and flag mounting brackets 460. FIG. 11 is a perspective view of a flag mounting bracket 460. The flag mounting bracket 460 has a hub 462, a first bracket tab 464, a second bracket tab 466, and a rotation stop member 480. The first and second bracket tabs 464, 466 include respective mounting holes 468, 470 for connecting the flag 200 to the flag mounting bracket 460. A portion of the flagpole 300 passes through the hub 462. FIG. 12 is a perspective view of a stop bracket 430. The stop bracket 430 has a body 432, a threaded hole 434, and a rotation stop member 438. A fastener 416, such as a set screw for example, is threaded into the hole 434 and secures the stop bracket 430 to the flagpole 300, see FIGS. 9 and 10. In some embodiments, the flag system 100 may include one or more retainers 410 to position the flag mounting brackets 460 on the flagpole 300 see FIGS. 2 and 10. The retainer 410 includes a fastener 416, such as a set screw for example, configured to secure the retainer 410 to the flagpole 300.

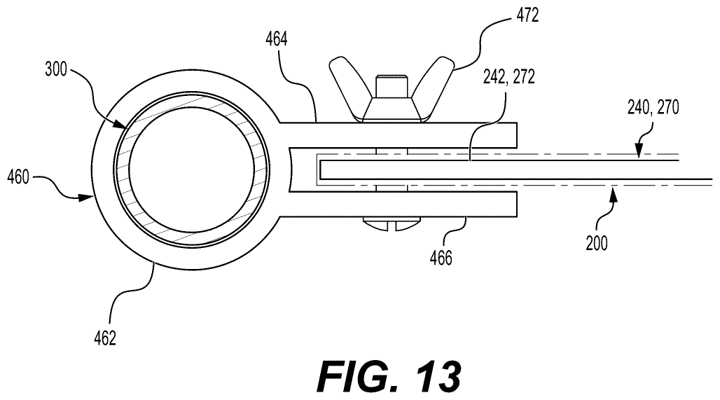

FIG. 13 is a detail view of a portion of the flag system of FIG. 1 illustrating the mounting of the flag 200 to the flag mounting brackets 460 and the flagpole 300. Portions of the flag 200 are shown in phantom for illustrative purposes. Fasteners 472 engage mounting holes 468, 470 and flag grommets 214, 218, see FIGS. 9, 10, and 11, to secure the flag 200 to the flag mounting brackets 460. The fasteners 472 may be threaded fasteners, such as a machine screw and nut, for example. In some embodiments, the fasteners 472 may be pins or other type of fastener configured to secure the flag 200 to the flag mounting brackets 460. The first end portions 242, 272 of the respective first and second elongated members 240, 270 are configured to be located between the first and second bracket tabs 464, 466.

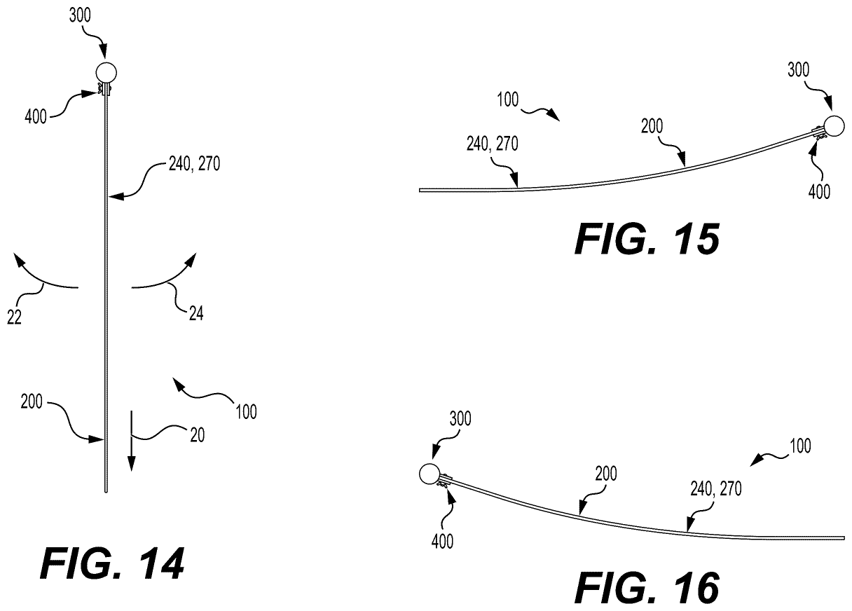

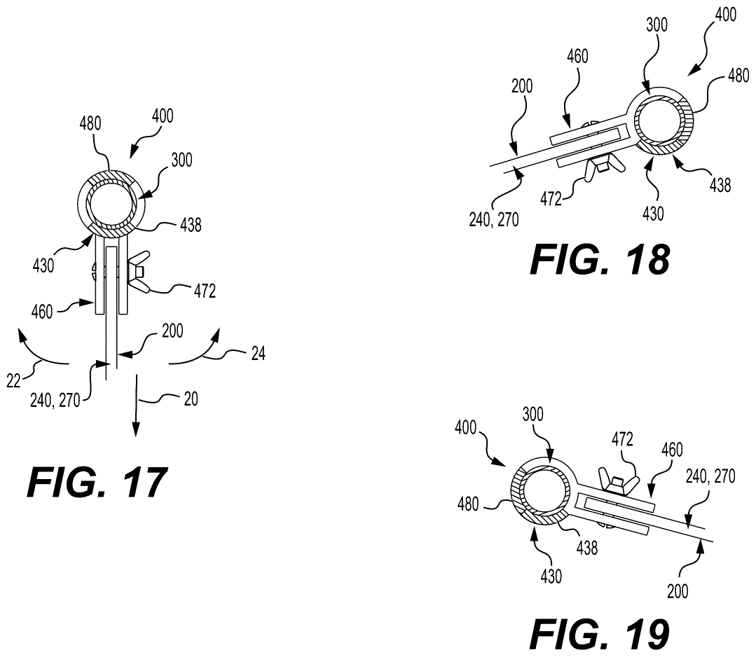

In some embodiments it may be desirable to limit the rotation of the flag 200 around the flagpole 300. Limiting the rotation of the flag 200 around the flagpole 300 may prevent the flag 200 from wrapping around the flagpole 300 or contacting or becoming entangled with objects or structures, for example. FIG. 14 is a simplified end view of the flag system 100 with the flag 200 hanging downward in the direction of arrow 20. FIG. 15 is a simplified end view of the flag system 100 with the flag 200 rotated clockwise approximately 70°-80°. FIG. 16 is a simplified end view of the flag system 100 with the flag 200 rotated counterclockwise approximately 70°-80°. In this illustrative embodiment, the flag 200 is allowed to rotate approximately 140°-160° around the flagpole 300. FIG. 17 is a partial section view of the flag system 100 with the flag 200 hanging downward. FIG. 18 is a partial section view of the flag system 100 with the flag 200 rotated clockwise approximately 70°-80°. FIG. 19 is a partial section view of the flag system 100 with the flag 200 rotated counterclockwise approximately 70°-80°.

Referring to FIGS. 14 and 17, when the flag 200 is hanging downward in the direction of arrow 20, the flag mounting brackets 460 allow the flag 200 to rotate clockwise, see arrow 22, and counterclockwise, see arrow 24, around the flagpole 300. Referring to FIGS. 15 and 18, the flag 200 is free to rotate clockwise until the rotation stop members 480 of the flag mounting brackets 460 contact the rotation stop members 438 of the stop brackets 430. Referring to FIGS. 16 and 19, the flag 200 is free to rotate counterclockwise until the rotation stop members 480 of the flag mounting brackets 460 contact the rotation stop members 438 of the stop brackets 430. When a force, such as wind, for example, is applied to the flag 200, the flag 200 may be biased in the direction of arrow 22 or 24 and the first and second elongated members 240, 270, as restrained by the flag mounting brackets 460, see FIG. 13, interacting with the stop brackets 430, to prevent the flag 200 from becoming wrapped around the flagpole 300. In this illustrative embodiment, the first and second elongated members 240, 270 are flexible yet resilient and this flexibility is illustrated in FIGS. 15 and 16 where the first and second elongated members 240, 270 are shown preventing the flag 200 from wrapping around the flagpole 300.

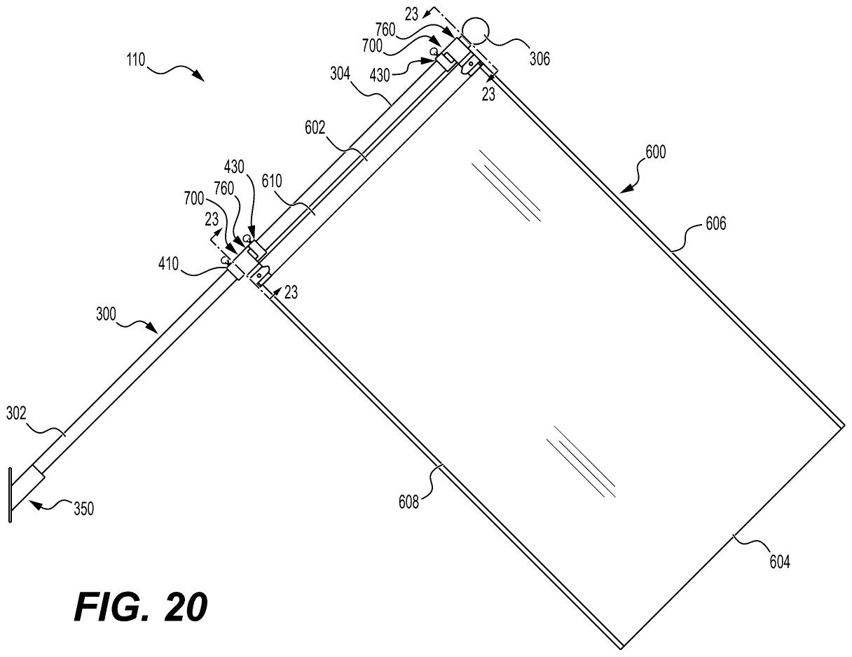

FIG. 20 is a perspective view of an alternative tangle resistant flag system 110. In this illustrative embodiment, the flag system 110 includes a flag 600, a flagpole 300, a flagpole mounting bracket 350, and flag mounting bracket assemblies 700. In this illustrative embodiment, the flag system 110 includes two flag mounting bracket assemblies 700 configured to couple the flag 600 to the flagpole 300. The flag mounting bracket assemblies 700 include flag mounting brackets 760 and stop brackets 430. In some embodiments, the flag system 110 may include one or more retainers 410 to position the flag mounting brackets 760 on the flagpole 300. Generally, the flag system 110 is similar in construction and operation to the flag system 100 described above and the flag system 110 may be substituted for other flag systems, or any feature of the flag system 110 may be used, in various other exemplary embodiments according to the present disclosure. Like reference numbers refer to like components. For brevity, the following description minimizes redundant description and focuses on the differences between the flag system 100 and the flag system 110.

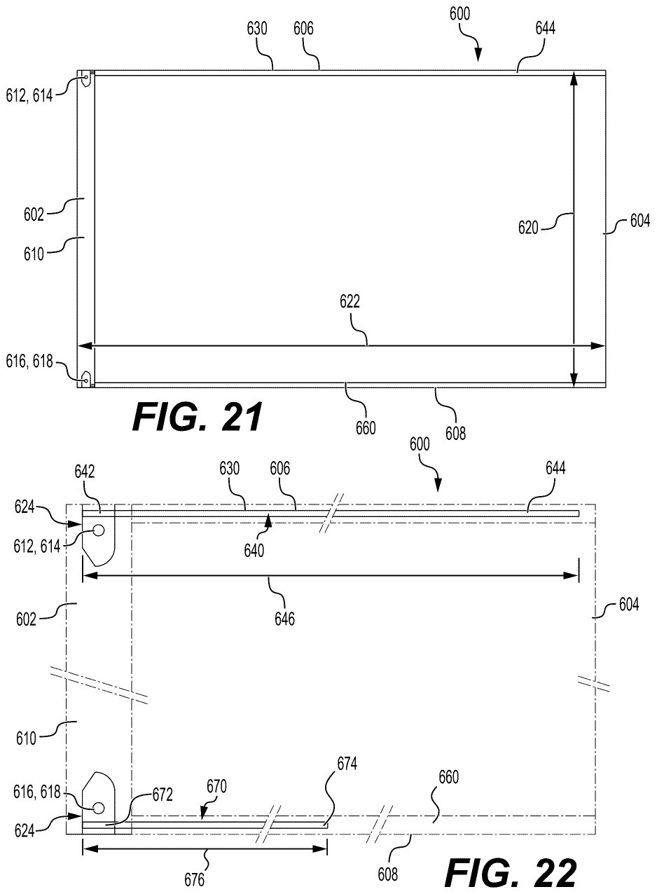

FIG. 21 is a front view of an illustrative embodiment of a flag 600. FIG. 22 is a fragmentary front view of the flag 600 with portions of the flag 600 shown in phantom for illustrative purposes. The flag 600 includes a pole side portion 602 and a the fly end portion 604. The flag 600 also includes an upper edge portion 606 and a lower edge portion 608. In this illustrative embodiment, the pole side portion 602 includes a header 610. The pole side portion 602 includes an upper mounting hole 612 and grommet 614 and a lower mounting hole 616 and grommet 618 located in the header 610 and configured for mounting the flag 600. The flag 600 has a width 620 and a length 622. The flag 600 has a first or upper flag pocket 630 running along at least a portion of the upper edge portion 606. A first elongated member 640 is at least partially contained in the first flag pocket 630. The first elongated member 640 has a first end portion 642 which is located proximate the pole side portion 602, a second end portion 644, and a length 646. The first elongated member 640 includes an anchor member 624 coupled to the first end portion 642 of the first elongated member 640. The anchor member 624 includes a hole 626 that is aligned with the upper mounting hole 612 and grommet 614 for coupling the flag 600 and the first elongated member 640 to a flag mounting bracket 760. In some embodiments, the anchor member 624 may be located inside the header, while in other embodiments, the anchor member 624 may be located outside the header 610.

The flag 600 has a second or lower flag pocket 660 running along at least a portion of the lower edge portion 608. A second elongated member 670 is at least partially contained in the second flag pocket 660. The second elongated member 670 has a first end portion 672 which is located proximate the pole side portion 602, a second end portion 674, and a length 676. The second elongated member 670 includes an anchor member 624 coupled to the first end portion 672 of the second elongated member 670. The anchor member 624 includes a hole 626 that is aligned with the lower mounting hole 616 and grommet 618 for coupling the flag 600 and the second elongated member 670 to a flag mounting bracket 760. In some embodiments, the anchor member 624 may be located inside the header, while in other embodiments, the anchor member 624 may be located outside the header 610.

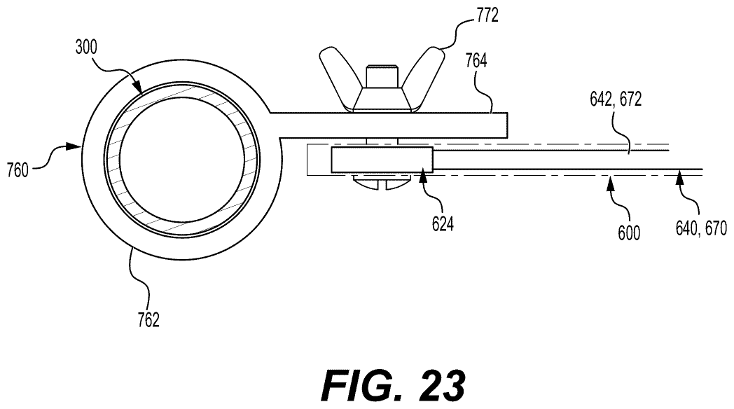

FIG. 23 is a detail view of a portion of the flag system of FIG. 20 illustrating the mounting of the flag 600 to the flag mounting brackets 760 and the flagpole 300. Portions of the flag 600 are shown in phantom for illustrative purposes. Fasteners 472 secure the flag 600 to the flag mounting brackets 760. The first end portions 642, 672 of the respective first and second elongated members 640, 670 are coupled by the anchor members 624 to the bracket tabs 764.

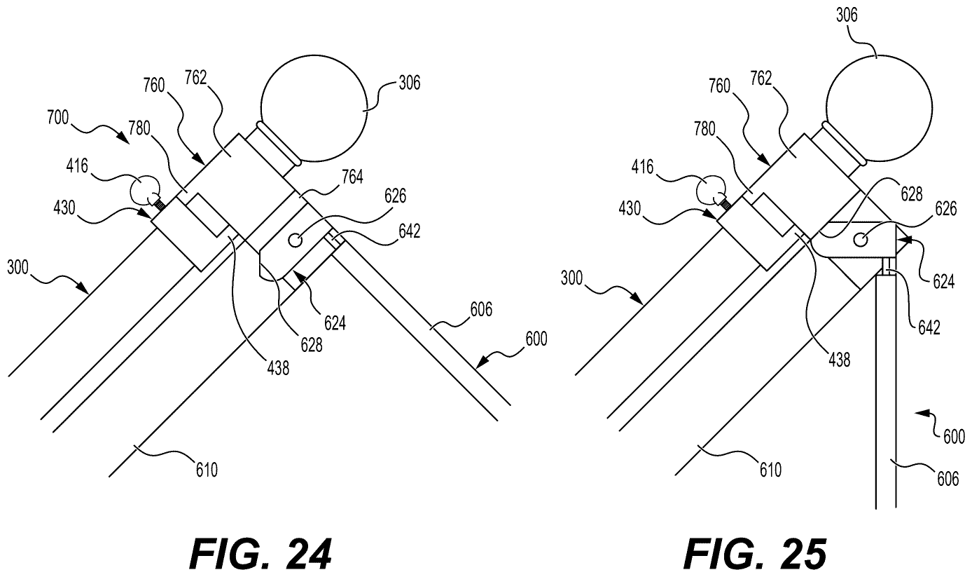

FIG. 24 is an elevation view of an upper portion of the flag system 110 including an upper corner portion of the flag 600, a portion of the flagpole 300, and a flag mounting bracket assembly 700. FIG. 25 is an elevation view of an upper portion of the flag system 110 including an upper corner portion of the flag 600, a portion of the flagpole 300, and a flag mounting bracket assembly 700 with the flag 600 hanging similarly to flag 200 in FIG. 1. The flag mounting bracket 760 has a hub 762, a bracket tab 764, and a rotation stop member 780. The anchor member 624 includes a stop portion 628 configured to limit the rotation of the anchor member 624 and the first elongated member 640 when the stop portion 628 contacts the hub 762 of the flag mounting bracket 760 as shown in FIG. 25.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A flag comprising:
a flag edge portion; and
an elongated member coupled to the flag edge portion and configured to prevent the flag from becoming tangled around a flagpole.

2. The flag of claim 1, wherein the flag edge portion comprises a flag pocket and the elongated member is at least partially contained in the flag pocket.

3. The flag of claim 1, wherein the elongated member extends at least half a length of the flag.

4. The flag of claim 1, further comprising a header;
wherein at least a portion of the elongated member extends into the header.

5. The flag of claim 1, wherein the flag edge portion comprises a first flag edge portion;
wherein the elongated member comprises a first elongated member; and
wherein the flag further comprises:
a second flag edge portion, and
a second elongated member coupled to the second flag edge portion and configured to prevent the flag from becoming tangled around the flagpole.

6. The flag of claim 5, wherein the first flag edge portion comprises a first flag pocket and the first elongated member is at least partially contained in the first flag pocket; and
wherein the second flag edge portion comprises a second flag pocket and the second elongated member is at least partially contained in the second flag pocket.

7. The flag of claim 5, wherein at least one of the first elongated member or the second elongated member extends at least half a length of the flag.

8. The flag of claim 5, further comprising a header;
wherein at least a portion of the first elongated member extends into the header; and
wherein at least a portion of the second elongated member extends into the header.

9. A flag system comprising:
a flag including:
a first flag edge portion,
a second flag edge portion,
a first elongated member coupled to the first flag edge portion and configured to prevent the flag from becoming tangled around a flagpole, and
a second elongated member coupled to the second flag edge portion and configured to prevent the flag from becoming tangled around the flagpole;
a first flag mounting bracket configured to couple the flag to a flagpole; and
a second flag mounting bracket configured to couple the flag to the flagpole.

10. The flag system of claim 9, wherein the first flag mounting bracket comprises a first bracket tab associated with the first elongated member; and
wherein the second flag mounting bracket comprises a second bracket tab associated with the second elongated member.

11. The flag system of claim 9, wherein the first flag mounting bracket comprises a first bracket tab and a second bracket tab and a portion of the first elongated member is configured to be located between the first bracket tab and the second bracket tab; and
wherein the second flag mounting bracket comprises a third bracket tab and a fourth bracket tab and a portion of the second elongated member is configured to be located between the third bracket tab and the fourth bracket tab.

12. The flag system of claim 9, wherein the first flag mounting bracket comprises a first flag mounting bracket stop member configured to limit rotation of the first flag mounting bracket around the flagpole; and
wherein the second flag mounting bracket comprises a second flag mounting bracket stop member configured to limit rotation of the second flag mounting bracket around the flagpole.

13. The flag system of claim 9, wherein the flag further comprises a header;
wherein at least a portion of the first elongated member extends into the header; and
wherein at least a portion of the second elongated member extends into the header.

14. The flag system of claim 9, wherein at least one of the first elongated member or the second elongated member extends at least half a length of the flag.

15. The flag system of claim 9, wherein at least one of the first elongated member or the second elongated member is flexible.

16. The flag system of claim 9, further comprising the flagpole.

17. A method of manufacturing a flag, the method comprising:
creating a flag pocket configured to receive at least a portion of an elongated member along at least a portion of a flag edge portion of the flag;
inserting at least a portion of an elongated member configured to prevent the flag from becoming tangled around a flagpole into the flag pocket.

18. The method of claim 17, wherein the method further comprises:
installing a header on the flag, and
inserting a portion of the elongated member into the header.

19. The method of claim 17, wherein the edge portion of the flag comprises a first edge portion;
wherein the flag pocket comprises a first flag pocket;
wherein the elongated member comprises a first elongated member; and
wherein the method further comprises:
creating a second flag pocket configured to receive at least a portion of an elongated member along at least a portion of a second edge portion of the flag;
inserting at least a portion of a second elongated member configured to prevent the flag from becoming tangled around the flagpole into the second flag pocket.

20. The method of claim 19, further comprising:
installing a header on the flag;
inserting a portion of the first elongated member into the header; and
inserting a portion of the second elongated member into the header.
